(19) United States
(12) Patent Application Publication
(10) Pub. No.: US 2023/0406220 A1
(43) Pub. Date: Dec. 21, 2023

(54) SHELVING FOR THE EXTERIOR OF A RECREATION VEHICLE

(71) Applicants: Dennis Morin, Ocklawaha, FL (US); Victoria Morin, Ocklawaha, FL (US)

(72) Inventors: Dennis Morin, Ocklawaha, FL (US); Victoria Morin, Ocklawaha, FL (US)

(21) Appl. No.: 17/844,717

(22) Filed: Jun. 21, 2022

(51) Int. Cl. B60R 11/00

(52) U.S. Cl. CPC B60R 11/00; B60R 2011/004; B60R 2011/0063; B60R 2011/0082

(57) ABSTRACT

A shelf for use with a recreational vehicle is presented. The shelf has an upper surface, a right-side surface and a left side surface. The shelf is foldable and is attached to an exterior surface of the RV preferably near an openable window located near a kitchen area of the RV. The shelf is attached to the exterior surface by an attachment means such as removable two-sided tape, adhesive, conventional two-sided tape, etc. Furthermore, the shelf is foldable and can be folding inward towards the exterior surface of the RV.

### FIELD OF THE INVENTION

This invention relates to shelving. More particularly, it relates to shelving attached to an exterior of a recreational vehicle.

### BACKGROUND

A recreational vehicle, often abbreviated as RV, is a motor vehicle or trailer which includes living quarters designed for accommodation. Types of RVs include motorhomes, campervans, coaches, caravans (also known as travel trailers and camper trailers), fifth-wheel trailers, popup campers, and truck campers.

RVs are most commonly used for living quarters while traveling. People may choose to take a road trip in their RV and use the RV to sleep in, rather than a hotel room. They may even decide to tow their car from the back of the RV so they can use that to travel around easier when they reach their destination. Although the most common usage of an RV is as temporary accommodation when traveling, some people use an RV as their main residence.

Typical amenities of an RV include a kitchen, a bathroom, and one or more sleeping facilities. RVs can range from utilitarian—containing only sleeping quarters and basic cooking facilities—to luxurious, with features like air conditioning (AC), water heaters, televisions and satellite receivers, and quartz countertops.

A shelf is a flat horizontal surface used for display and storage raised off the floor and often anchored to a wall or other vertical surfaces supported on its shorter length sides by brackets. A shelf is also known as a counter, ledge, mantel, or rack. An RV contains multiple shelves inside the RV itself but does not contain a shelf attached to the exterior of the RV.

According, and in light of the foregoing, it would be desirable to have a folding shelf attached to the exterior of the RV to be used as a kitchen preparation station. It is also desirable for the shelve to be permanently attached to the exterior and stored in a folded manner when not in use. It is further desirable for the shelf to be deployed when needed and necessary kitchen supplies can be transferred from the inside kitchen area to the exterior shelf unit.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a pictorial view of the attachable folding shelf 10, shown in an installed and deployed state on a recreational vehicle 15, according to the preferred embodiment of the present invention;

FIG. 2 is a detailed isometric view of the attachable folding shelf 10, shown in a deployed and utilized state, according to the preferred embodiment of the present invention;

FIG. 3 is a detailed isometric view of the attachable folding shelf 10, shown in a partially deployed state, according to the preferred embodiment of the present invention;

FIG. 4 is a detailed isometric view of the attachable folding shelf 10, shown in a retracted state, according to the preferred embodiment of the present invention; and,

FIG. 5 is a sectional view of the attachable folding shelf 10, as seen along a line I-I, as shown in FIG. 2, according to the preferred embodiment of the present invention.

### DESCRIPTIVE KEY

10 attachable folding shelf
15 recreational vehicle
20 exterior surface
25 upper surface
30 left side surface
35 right side surface
40 exterior window
45 kitchen area
50 exterior cooking area
55 cooking item
60 transfer path “a”
65 retaining means
70 side storage pocket
75 grilling tool
80 hanging hook
85 aprons
90 clips
95 rolled materials
100 fold-down shelf
105 sauce
110 hinge
115 inward/outward travel path “i”
120 first latch clip
125 downward/upward travel path “d”
130 second latch clip
135 length “1”
140 attachment means

### DESCRIPTION OF THE PREFERRED EMBODIMENTS

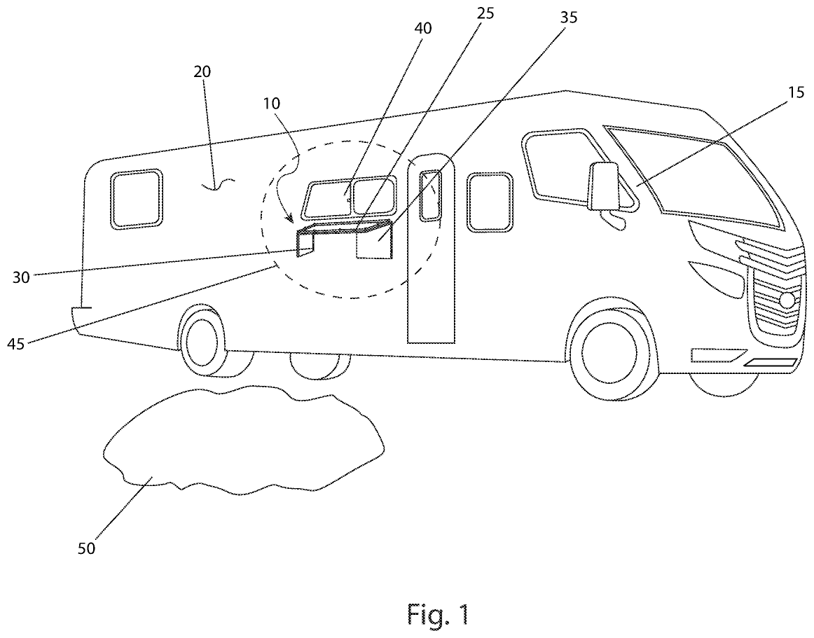

The best mode for carrying out the invention is presented in terms of its preferred embodiment, herein depicted within FIGS. 1 through 5. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. DETAILED DESCRIPTION OF THE FIGURES

Referring now to FIG. 1, a pictorial view of the attachable folding shelf 10, shown in an installed and deployed state on a recreational vehicle 15, according to the preferred embodiment of the present invention is disclosed. The attachable folding shelf (herein also described as the “folding shelf”) 10, provides an area to hold various cooking items as they are transferred between the interior and exterior of a recreational vehicle as well as a holding area for cooking related items. The folding shelf 10 is attached to a recreational vehicle 15 on its exterior surface 20. The recreational vehicle 15 may be a class A (as shown), class B, class C, travel trailer, fifth wheel, truck camper, conversion van, or similar. The type of recreational vehicle 15 used with the folding shelf 10 is not intended to be a limiting factor of the present invention. The folding shelf 10 comprises an upper surface 25, a left side surface 30 and a right-side surface 35 which will be described in greater detail herein below. The folding shelf 10 is located below an exterior window 40 on the recreational vehicle 15 that is capable of being opened and is preferably near a kitchen area 45 (here shown via a dashed line due to its hidden nature). This location would also be near an exterior cooking area 50 on the outside of the recreational vehicle 15 and contain items including but not limited to picnic tables, grills, fire rings, and the like. The upper surface 25 may vary in size per application, however, a typical size is envisioned to be approximately twenty-four inches (24 in.) wide and sixteen inches (16 in.) deep. The exact size of the folding shelf 10 is not intended to be a limiting factor of the present invention.

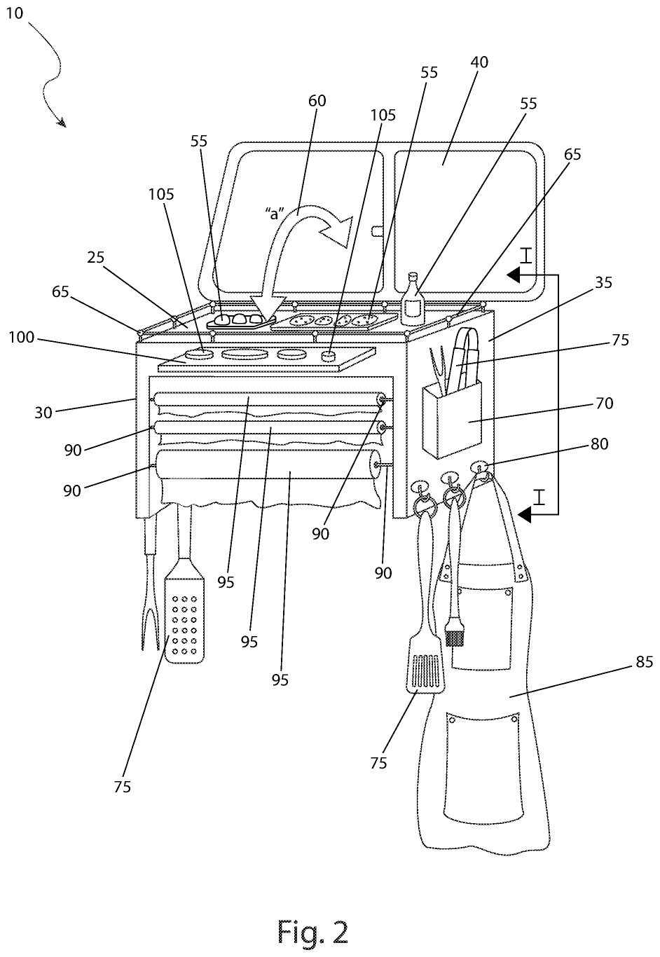

Referring next to FIG. 2, a detailed isometric view of the folding shelf 10, shown in a deployed and utilized state, according to the preferred embodiment of the present invention is depicted. The folding shelf 10 consisting of the upper surface 25, the left side surface 30, and the right-side surface 35 is attached to the exterior surface 20 below the exterior window 40, as aforementioned described. This positioning allows for the transfer of cooking items 55 between the folding shelf 10 and the kitchen area 45 (as shown in FIG. 1) along a transfer path “a” 60 through the open exterior window 40. The upper surface 25 is provided with a retaining means 65 such as a molded edge, lip, cable support (as shown), or the like, to prevent cooking items 55 from falling off the upper surface 25. The right-side surface 35 is provided with a side storage pocket 70 for holding of grilling tools 75 and associated cooking items 55. A side storage pocket 70 is also provided on the left side surface 30 but is not visible due to illustrative limitations. Both the left side surface 30 and the right-side surface 35 are equipped with hanging hooks 80 (visible only on the right-side surface 35 due to illustrative limitations) to hold items such as grilling tools 75, aprons 85, and the like according to the preference of the user. The left side surface 30 and the right-side surface 35 are provided with clips 90, arranged in a symmetrical pattern to hold rolled materials 95 such as paper towels, aluminum foil, plastic wrap, or the like. A fold-down shelf 100 is provided directly below the forward edge of the upper surface 25 for holding sauces 105 or the like.

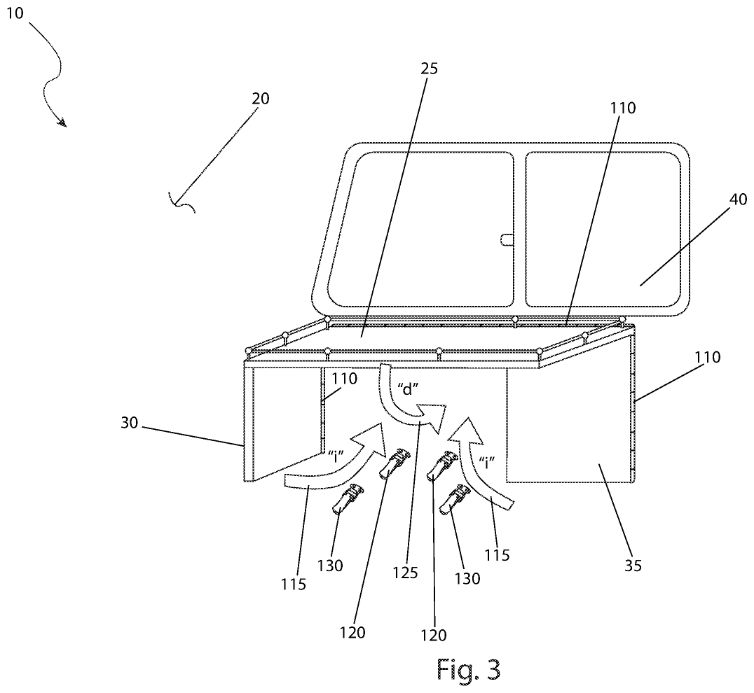

Referring now to FIG. 3, a detailed isometric view of the folding shelf 10, shown in a partially deployed state, according to the preferred embodiment of the present invention is shown. When the functionality of the folding shelf 10 is not required, it may be retracted by folding it up against the exterior surface 20. The retraction process involves the removal of all cooking items 55, grilling tools 75, aprons 85, rolled materials 95, and sauces 105 (all of which are shown in FIG. 2). Next, the left side surface 30 and the right-side surface 35 are folded inward via a hinge 110 along an inward/outward travel path “i” 115. The left side surface 30 and the right-side surface 35 are secured via first latch clips 120 that are centrally-located. Finally, with the supporting structure of the left side surface 30 and the right-side surface 35 now removed, the upper surface 25 is free to fold downward via a hinge 110, along a downward/upward travel path “d” 125 and is secured via a set of second latch clips 130. During deployment of the folding shelf 10, the above-mentioned process is reversed.

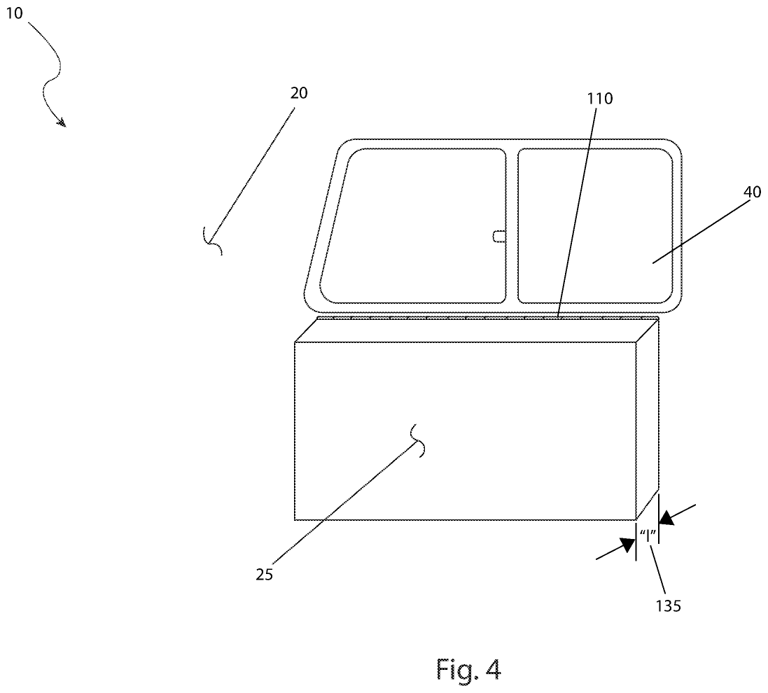

Referring next to FIG. 4, a detailed isometric view of the folding shelf 10, shown in a retracted state, according to the preferred embodiment of the present invention is disclosed. This state exposes the upper surface 25 in its entirety in a parallel manner to the exterior surface 20. The hinge 110 for the upper surface 25 is visible along the top surface. This stowed configuration allows the recreational vehicle 15 (as shown in FIG. 1) to be in transit with the folding shelf 10 remaining in place. The folding shelf 10 protrudes approximately a length “1” 135 of approximately four inches (4 in.). The length “1” 135 does not interfere with travel, lane clearance, operation, or other factors associated with normal use of the recreational vehicle 15.

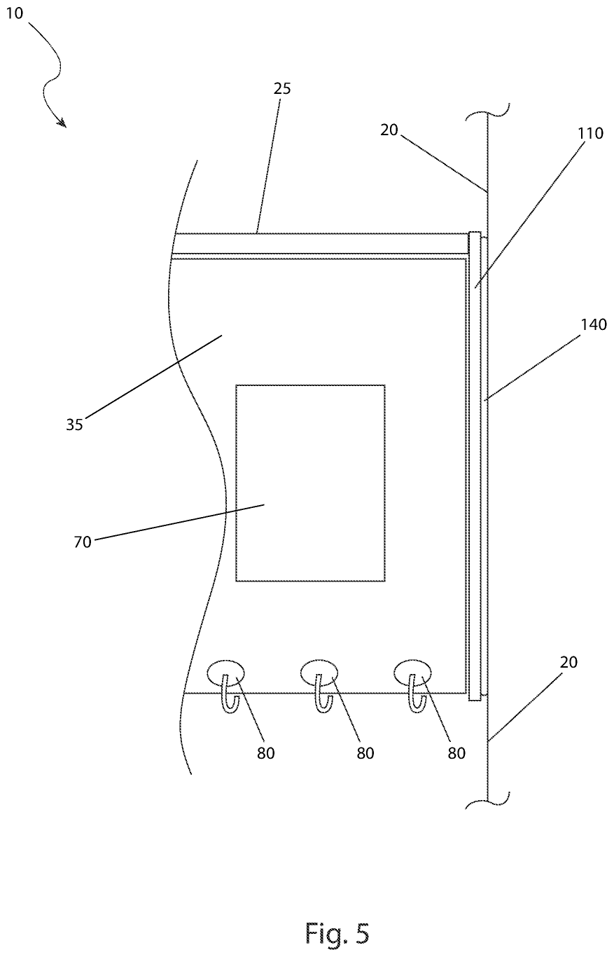

Referring now to FIG. 5, a sectional view of the folding shelf 10, as seen along a line I-I, as shown in FIG. 2, according to the preferred embodiment of the present invention is depicted. The folding shelf 10 is secured to the exterior surface 20 via an attachment means 140 such as double-sided removable tape, adhesive, conventional double-sided tape, or similar means. The exact method employed by the attachment means 140 is not intended to be a limiting factor of the present invention. The attachment means 140 allows the folding shelf 10 in instances where it is no longer needed, to be moved to a different recreational vehicle 15 (as shown in FIG. 1), moved to a different location on the same recreational vehicle 15 or the like. The attachment means 140 connects to the hinge 110 on the right-side surface 35 as shown as well as the hinge 110 as used on the upper surface 25 and the left side surface 30 (both of which are as shown in FIGS. 1, 2, and 3). The side storage pocket 70 and the hanging hooks 80 are thusly visible on the right-side surface 35.

### 2. OPERATION OF THE PREFERRED EMBODIMENT

The preferred embodiment of the present invention can be utilized by the common user in a simple and effortless manner with little or no training. It is envisioned that the folding shelf 10 would be constructed in general accordance with FIG. 1 through FIG. 5. The user would procure the folding shelf 10 from conventional procurement channels such as recreational vehicle dealers, camping accessory stores, sporting goods stores, discount stores, mail order and internet supply houses and the like. Special attention would be paid to the overall size of the folding shelf 10 and various accessories provided herewith.

After procurement and prior to utilization, the folding shelf 10 would be prepared in the following manner: a location on the exterior surface 20 of the recreational vehicle 15, below a exterior window 40 and near a kitchen area 45 would be chosen as an installation location; said chosen area would be cleaned and the attachment means 140 applied to one-half of the hinge 110 for the upper surface 25, the left side surface 30 and the right side surface 35; the folding shelf 10 is then positioned as a unit and attached to the exterior surface 20. At this point in time, the folding shelf 10 is ready for utilization.

During utilization of the folding shelf 10, the following procedure would be initiated: during deployment, the upper surface 25 is disconnected from the second latch clips 130 and lifted upward along the downward/upward travel path “d” 125; the left side surface 30 and the right side surface 35 are then moved outward along the downward/upward travel path “d” 125; the upper surface 25 then sits upon the left side surface 30 and the right side surface 35; various items such as cooking items 55, grilling tools 75, aprons 85, rolled materials 95 and sauces 105 are then positioned upon the upper surface 25, the side storage pocket 70, the hanging hooks 80, the clips 90, and the fold down shelf 100 as desired by the user. This action facilitates the cooking process on the exterior cooking area 50 and eases the transfer of cooking items from the kitchen area 45 to the exterior cooking area 50 and back again once the cooking process is completed.

After use of the folding shelf 10, it is retracted and stored as shown in FIG. 4 by reversing the deployment process as described above. The folding shelf 10 remains in a collapsed state until its features are needed again in a repeating and cyclic process.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A shelf for an exterior of a recreational vehicle (RV), the shelf comprising:
an upper surface;
a left-side surface, the left-side surface is coupled to the upper surface; and
a right surface-side, the right-side surface is coupled to the upper surface, wherein the upper surface, left-side surface and right-side surface are attached to an exterior surface of an RV below an exterior window.

2. The shelf according to claim 1, wherein the upper surface is twenty-four inches in width.

3. The shelf according to claim 1, wherein the upper surface is sixteen inches in depth.

4. The shelf according to claim 1, wherein the upper surface has a retaining means, wherein the retaining means for preventing items cooking from falling off of the upper surface.

5. The shelf according to claim 4, wherein the retaining means being a molded edge.

6. The shelf according to claim 4, wherein the retaining means being a cable support.

7. The shelf according to claim 1, wherein the right-side surface has a first side storage pocket, the side storage pocket being for holding grilling tools and cooking items.

8. The shelf according to claim 1, wherein the left-side surface has a first side storage pocket, the side storage pocket being for holding grilling tools and cooking items.

9. The shelf according to claim 1, wherein each of the right-side surface and the left-side surface have a one or more hanging hooks to hold one or more items.

10. The shelf according to claim 9, wherein the one or more items being at least one of: grilling tools, an apron.

11. The shelf according to claim 1, wherein each of the right-side surface and the left-side surface has a plurality of clips, the clips being arranged in a symmetrical pattern, wherein the clips holding a rolled material.

12. The shelf according to claim 11, wherein the rolled material being at one of: a roll of paper towels, aluminum foil, a plastic wrap.

13. The shelf according to claim 1, wherein the shelf is foldable.

14. The shelf according to claim 1, wherein the shelf is retractable, wherein the shelf is folded up against the exterior surface of the RV.

15. The shelf according to claim 1, wherein the shelf being located near an exterior cooking area on an outside of the RV.

16. The shelf according to claim 1, wherein the exterior cooking area has one or more of: a picnic table, a grill, a fire ring.

17. The shelf according to claim 1, wherein the shelf having a location below the exterior window of the RV, the exterior window of the RV being openable, wherein the exterior window being near a kitchen area of the RV.

18. The shelf according to claim 1, wherein the RV is a class A RV.

19. The shelf according to claim 1, wherein the shelf is attached to the exterior surface of the RV by an attachable means.

20. The shelf according to claim 1, wherein the attachable means being one of: a double-sided removable tape, adhesive, conventional double-sided tape.
